(19) United States
(12) Patent Application Publication
(10) Pub. No.: US 2026/0321534 A1
(43) Pub. Date: Oct. 15, 2026

(54) PRE-IGNITION DEVICE FOR A HIGH-VOLTAGE VACUUM INTERRUPTER

(71) Applicant: Siemens Energy Global GmbH & Co. KG, München (DE)

(72) Inventors: Stefan Giere, Falkensee (DE); Thomas Heinz, Berlin (DE); Sylvio Kosse, Coswig (DE); Jörg Teichmann, Dallgow-Döberitz (DE); Jan Weisker, Brieselang (DE); Stefan Wilke, Dallgow-Döberitz (DE)

(21) Appl. No.: 18/998,669

(22) PCT Filed: Jul. 18, 2023
(86) PCT No.: PCT/EP2023/069868

§ 371 Date: Jan. 27, 2025

(30) Foreign Application Priority Data
Jul. 26, 2022 (DE) 10 2022 207 630.3

(51) Int. Cl. H01H 33/12; H01H 33/662; H01H 33/666

(52) U.S. Cl. CPC H01H 33/12; H01H 33/662; H01H 33/666

(57) ABSTRACT

A high-voltage switching device has a high-voltage vacuum interrupter and a pre-ignition device connected in parallel with the vacuum interrupter in order to reduce contact wear. Variants relate to the temporal switching order of the vacuum interrupter and the pre-ignition device. There is provided a technically robust system which allows reliable switching under the conditions of high-voltage and high currents and a long electrical service life.

The invention relates to a high-voltage switching device having a pre-ignition device and to a method for operating said high-voltage switching device.

Frequently switching on with high currents specifically in vacuum interrupters may result in damage to the contacts of a circuit breaker, which ultimately limits the electrical and mechanical lifetime. Switching off a high current can counteract the damage since local melting of the contact surface arising during switch-off results in electrical smoothing of the contact surface. However, when the switch is used in a capacitive load, such as a capacitor bank, for example, the breaking current is too low for said smoothing effect to occur. Particularly in the case of vacuum switches and particularly in high-voltage technology, this may result in a significantly limited lifetime but also in an unpermitted number of reignitions.

At medium voltage, this phenomenon is resolved kinematically by suitably selected coordination between switch-on and switch-off speed. The positive effect of this here is that the so-called pre-ignition times, that is to say the reaction time of the arc arising upon switch-on, are very low due to the relatively low voltages. However, this is not the case at high voltage; in this case, the pre-ignition times differ significantly from zero.

The invention is based on the problem of specifying a solution as to how wear of a high-voltage vacuum interrupter can be significantly reduced.

The problem is solved by a high-voltage switching device having a pre-ignition device comprising the features of claim 1 and by a method for operating said high-voltage switching device comprising the features of claim 7.

The high-voltage vacuum switching device according to the invention has an additional switch-on contact outside of the vacuum interrupter such that the switch-on arc does not occur in the vacuum tube and does not damage the vacuum tube.

The solution according to the invention provides a technically robust system which under the conditions of high voltage and high currents exhibits reliable switching at the same time as a long electrical lifetime.

The main contact 12 of the main switching unit 2 can be designed in optimized fashion to carry the current and the auxiliary contact 13 of the auxiliary switching unit 3 can be designed in optimized fashion to switch the current. This is particularly relevant for a configuration of the invention in which the auxiliary switching unit 3 is formed with an additional vacuum tube, in particular as an auxiliary contact 13 in the inrush current path.

In a particular configuration of the invention, the auxiliary contact and/or the main contact are switched on and off in a phase-controlled manner. By way of this measure, possibly during operation with AC voltage, the time and the phase position, respectively, of the opening and closing of the main contact and/or auxiliary contact, in particular by way of the drive unit in conjunction with the gear mechanism, is controlled in such a way that reduced contact wear can be expected.

Advantageous developments of the invention are specified in the dependent claims.

The invention is explained in more detail below as an exemplary embodiment to an extent required for understanding based on figures. In the figures:

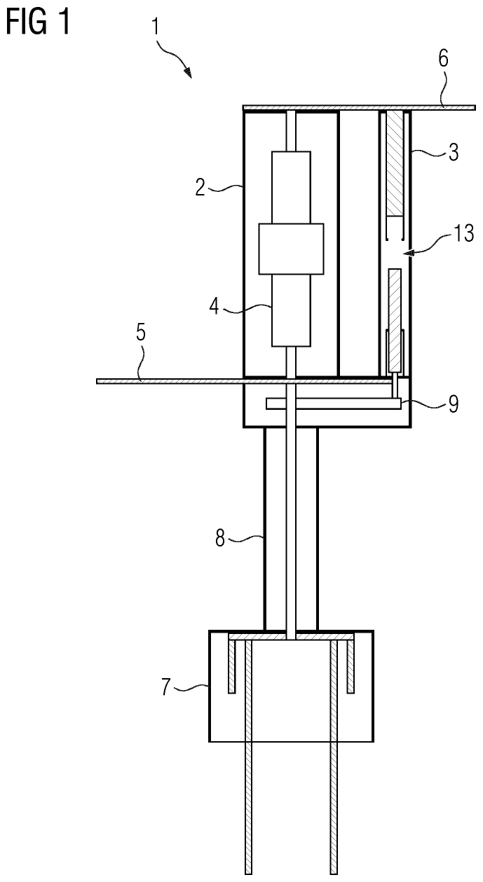

FIG. 1 shows a high-voltage vacuum switching device 1 according to the invention having a main switching unit 2 and a separate auxiliary switching unit 3,

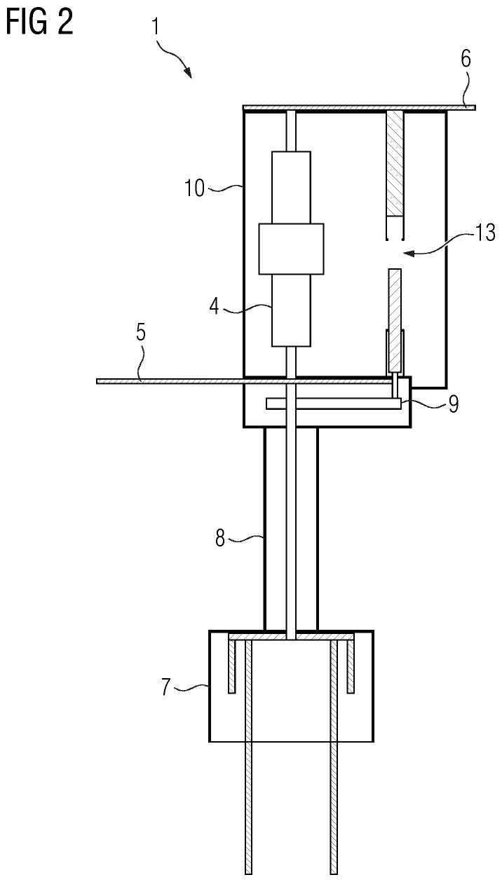

FIG. 2 shows a high-voltage vacuum switching device according to the invention having a main switching unit and an integrated auxiliary switching unit,

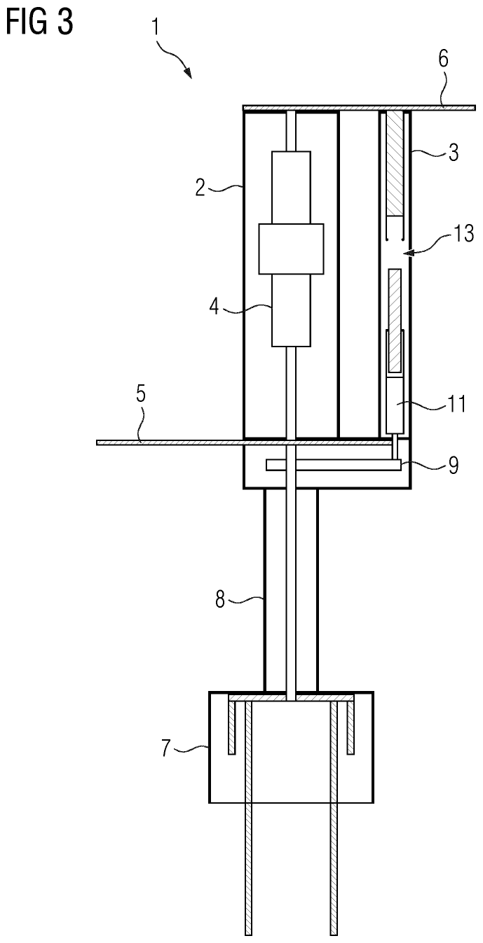

FIG. 3 shows a high-voltage vacuum switching device according to the invention having a main switching unit and an auxiliary switching unit having an inrush resistor,

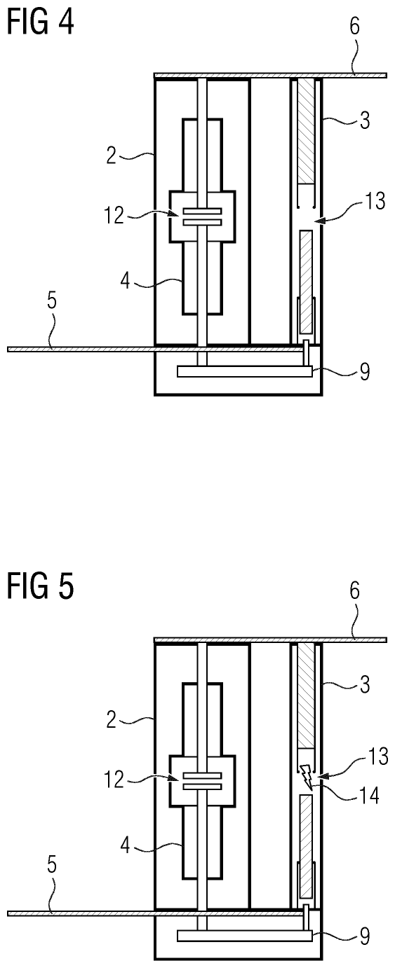

FIG. 4 shows a switching sequence of the high-voltage vacuum switching device according to the invention, switch in off,

FIG. 5 shows a switching sequence of the high-voltage vacuum switching device according to the invention, pre-ignition at the auxiliary contact in the insulating gas,

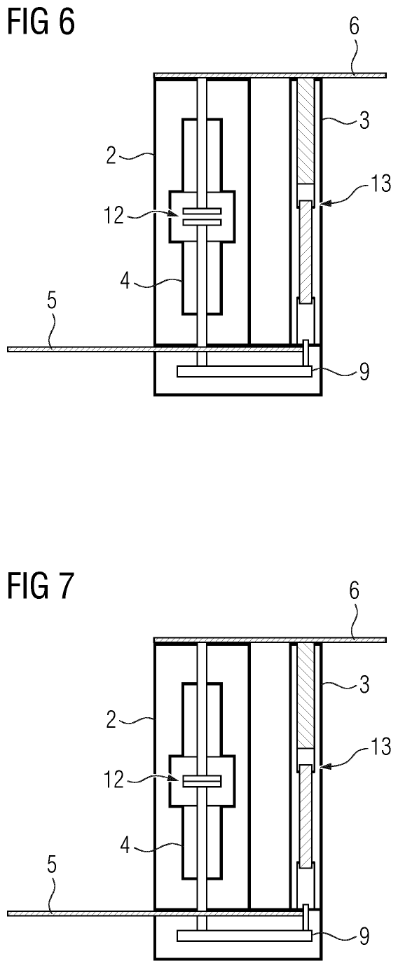

FIG. 6 shows a switching sequence of the high-voltage vacuum switching device according to the invention, auxiliary contact closes,

FIG. 7 shows a switching sequence of the high-voltage vacuum switching device according to the invention, main contact closes and

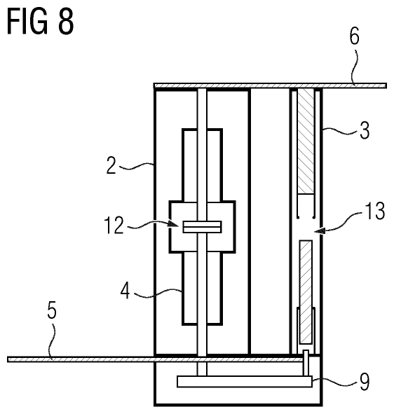

FIG. 8 shows a switching sequence of the high-voltage vacuum switching device according to the invention, auxiliary contact opens.

In the figures, the same references denote the same elements.

FIG. 1 shows a main switching unit 2 which is formed with a high-voltage vacuum interrupter 4 having a main contact and which is electrically connected to a current supply 5 and a current output 6. An auxiliary switching unit 3 is electrically connected to the current supply 5 and current output 6, whereby the auxiliary switching unit 3 is connected in parallel with the main switching unit 2. An auxiliary contact 13 is arranged in the housing of the auxiliary switching unit 3.

The auxiliary switching unit 3 forms a pre-ignition device for the main switching unit 2. The main switching unit 2 and the auxiliary switching unit 3 are arranged in separate housings, in particular separate insulating containers. The housing of the auxiliary switching unit 3 may be hermetically filled with an insulating gas which in particular is free from sulfur hexafluoride (free from SF6). The main switching unit 2 and the auxiliary switching unit 3 are mechanically actuatable by means of a drive unit 7, an insulating rod 8 and a gear mechanism 9 in such a way that the temporal sequence of closing and opening the main contact in the main switching unit 2 and the auxiliary contact in the auxiliary switching unit 3 is controlled.

The high-voltage vacuum switching device 1 according to FIG. 2 differs from the high-voltage vacuum switching device 1 according to FIG. 1 in that the high-voltage vacuum interrupter 4 of the main switching unit 2 and the switching contact 13 of the auxiliary switching unit 3 are arranged in a joint housing, in particular joint insulating container 10.

Compared to the high-voltage vacuum switching device 1 according to FIG. 1, the high-voltage vacuum switching device 1 according to FIG. 3 additionally has an inrush resistor 11 which is electrically connected between the current supply 5 and the current output 6 in series with the auxiliary contact 13 of the auxiliary switching unit 3. The auxiliary contact of the auxiliary switching unit 3 and the inrush resistor 11 may be arranged together in one housing, in particular insulating container. The inrush resistor 11 limits the inrush current.

FIG. 4 to FIG. 8 show characteristic switching sequences of closing and opening the main contact 12 in the main switching unit 2 and the auxiliary contact 13 in the auxiliary switching unit 3, these switching sequences being controlled by means of the drive unit 7 and the gear mechanism 9. The illustration of the drive unit and the insulating rod is omitted for the sake of clarity. In the switching sequence of FIG. 4, the high-voltage vacuum switching device 1 is switched off, the main contact 12 in the main switching unit 2 and the auxiliary contact 13 in the auxiliary switching unit 3 are open. In the switching sequence of FIG. 5, the bottom contact piece of the auxiliary contact 13 is moved a subsection of the entire contact path upward by means of the drive unit, wherein pre-ignition 14 at the auxiliary contact in the insulating gas takes place. In the switching sequence of FIG. 6, the bottom contact piece of the auxiliary contact 13 is moved the entire contact path upward by means of the drive unit, the auxiliary contact 13 is closed. In the switching sequence of FIG. 7, the bottom contact piece of the auxiliary contact is moved the entire contact path upward by means of the drive unit, the auxiliary contact is closed, the main contact is closed by means of the drive unit. In the switching sequence of FIG. 8, the bottom contact piece of the auxiliary contact is moved the entire contact path downward by means of the drive unit, the auxiliary contact 13 is open, the main contact 12 is closed.

High-voltage in the context of the invention is understood as meaning a voltage of 72.5 kilovolts and more.

The present invention has been explained in detail for illustrative purposes based on specific exemplary embodiments. In this case, elements of the individual exemplary embodiments. may also be combined with one another. The invention is therefore not intended to be limited to individual exemplary embodiments but only limited by the appended claims.

### LIST OF REFERENCE SIGNS

1 High-voltage vacuum switching device
2 Main switching unit
3 Auxiliary switching unit, pre-ignition device
4 Vacuum interrupter
5 Current supply
6 Current output
7 Drive unit
8 Insulating rod
9 Gear mechanism
10 Joint housing
11 Inrush resistor for current limitation
12 Main contact
13 Auxiliary contact
14 Pre-ignition at the auxiliary contact
a Switch in off
b Pre-ignition at the auxiliary contact in the insulating gas
c Auxiliary contact closes
d Main contact closes
e Auxiliary contant opens

1-10. (canceled)

11. A high-voltage switching device, comprising
a main switching unit having a high-voltage vacuum interrupter with a main contact, said main switching unit being is electrically connected to a current supply and a current output;
an auxiliary switching unit having an auxiliary contact electrically connected to the current supply and to the current output, said auxiliary switching unit forming a pre-ignition device for said high-voltage vacuum interrupter; and
a drive unit configured to mechanically actuate said high-voltage vacuum interrupter and to actuate said auxiliary switching unit forming said pre-ignition device.

12. The high-voltage switching device according to claim 11, wherein said auxiliary unit has a housing which is filled with an insulating gas.

13. The high-voltage switching device according to claim 12, wherein said insulating gas is free from sulfur hexafluoride.

14. The high-voltage switching device according to claim 11, which comprises a joint housing commonly enclosing said main switching unit and said auxiliary switching unit.

15. The high-voltage switching device according to claim 11, wherein said auxiliary switching unit is formed with an additional vacuum tube.

16. The high-voltage switching device according to claim 15, wherein said additional vacuum tube forms an auxiliary contact in an inrush current path.

17. The high-voltage switching device according to claim 11, wherein said auxiliary switching unit comprises an ohmic resistor connected in series with said auxiliary contact for limiting an inrush current.

18. The high-voltage switching device according to claim 11, further comprising an insulating rod and a gear mechanism, and wherein said main switching unit and said auxiliary switching unit are mechanically actuatable by way of said drive unit, said insulating rod, and said gear mechanism to enable a temporal sequence of closing and opening said main contact in said main switching unit and said auxiliary contact in said auxiliary switching unit to be controlled.

19. A method of operating a high-voltage switching device, the method comprising:
providing the high-voltage switching device according to claim 11;
proceeding from a switching state in which both the main contact and the auxiliary contact are open, first closing the auxiliary contact and subsequently closing the main contact.

20. The method according to claim 19, which comprises:
proceeding from a switching state in which both the main contact and the auxiliary contact are closed, first opening the auxiliary contact and subsequently opening the main contact.

21. The method according to claim 19, which comprises switching on at least one of the auxiliary contact or the main contact in a phase-controlled manner to limit a contact loading caused by a high inrush current.

22. The method according to claim 19, which comprises switching off at least one of the auxiliary contact or the main contact in a phase-controlled manner.
